(19) United States
(12) Patent Application Publication
(10) Pub. No.: US 2009/0147093 A1
(43) Pub. Date: Jun. 11, 2009

(54) COLOR PROCESSING CIRCUIT

(75) Inventor: PEI-CHONG TANG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/198,044

(22) Filed: Aug. 25, 2008

(30) Foreign Application Priority Data
Dec. 10, 2007 (CN) 200710202956.X

(51) Int. Cl. H04N 5/228

(52) U.S. Cl. 348/222.1; 348/E05.031

(57) ABSTRACT

An image processing apparatus includes an image sensor and a color processing circuit. The image sensor outputs single color image signals to the color processing circuit. The color processing circuit includes a delay unit and a process unit. The delay unit delays the single color image signals belonging to multiple pixels to be stored in the delay unit. The process unit retrieves the single color image signals belonging to multiple pixels simultaneously, and determines a set of complete red, green, and blue values for at least part of pixels of the image sensor using an interpolation algorithm.

### BACKGROUND

1. Technical Field

The disclosed embodiments generally relate to image processing apparatuses, and particularly to an image processing apparatus comprising a color processing circuit.

2. Description of related art

Image sensors such as charge coupled device (CCD) image sensors and complementary metal oxide semiconductor (CMOS) image sensors are widely used in image processing apparatuses (e.g., digital cameras, camcorders, and scanners). Typically, an image sensor includes a plurality of photo-sensors (also referred as pixels) arranged in multiple rows and multiple columns. The plurality of photo-sensors can convert image light to image signals for constructing an image. However, the photo-sensors by themselves are not able to detect light with a wavelength range. In other words, the photo-sensors cannot separate color information.

Therefore, a color filter array (CFA) may be employed in an image sensor to obtain color information. One typical pattern of the CFA is 50% green, 25% red, and 25% blue, hence is also called GRGB or other permutation such as RGGB, so as to simulate the human eye's greater resolving power with green light. This typical pattern is also called Bayer pattern, in honor of the person who has invented the pattern. The CFA is able to filter image light by wavelength range, such that filtered light includes color information about the image light.

Because each pixel is filtered to record only one of three colors, two-thirds of the color data is missing from each pixel. In order to obtain a full-color image, various interpolation algorithms have been used to determine a set of complete red, green, and blue values for each pixel. Different interpolation algorithms requiring various amounts of computing power result in varying quality of captured images.

Referring to FIG. 8, one such interpolation algorithm uses four neighboring pixels such as BGGR to determine a set of complete red, green, and blue values for each pixel. Referring to FIG. 9, another such interpolation algorithm uses nine neighboring pixels to determine a set of complete red, green, and blue values for each pixel.

However, before implementing either the first or the second interpolation algorithm, the image data outputted from the image sensor should be stored in a buffer memory. Then, a process unit coupled to the buffer memory reads the image data serially from the buffer memory. As a result, it costs a relatively longer time for the process unit to receive a set of complete red, green, and blue values for each pixel.

Therefore, a method for reducing receiving time during implementing the interpolation algorithm for determining a set of complete red, green, and blue values of each pixel is desired.

### SUMMARY

Accordingly, an image processing apparatus is provided. The image sensor includes a plurality of photo-sensors arranged in an array having multiple rows and multiple columns, and a color filter array positioned over the multiple photo-sensors. The color filter array filters image light originating from an object to generate a single color image light. The plurality of photo-sensors convert the single color image light to generate single color image signals. The single color image signals belonging to each photo-sensor contains color information selected from the group consisting of red, blue, or green. A color processing circuit is coupled to the image sensor. The color processing circuit includes a delay unit and a process unit. The delay unit receives single color image signals outputted from the image sensor, and delays the received single color image signals belonging to a plurality of pixels to be stored in the delay unit. The process unit is coupled to the delay unit for retrieving the single color image signals simultaneously, and determines a set of complete red, green, and blue values for at least part of pixels of the image sensor using an interpolation algorithm.

Other advantages and novel features will become more apparent from the following detailed description of exemplary embodiment when taken in conjunction with the accompanying drawings.

### BRIEF DESCRIPTION OF THE DRAWINGS

FIG. 1 is a block diagram of an image processing apparatus employing a color processing circuit according to one embodiment of the present disclosure, the image processing apparatus including an image sensor, and the color processing circuit including a delay unit and a process unit.

FIG. 2 is one embodiment of a pattern of the color filter array of the image sensor.

FIG. 3 is another embodiment of a circuit diagram of the color processing circuit in FIG. 1.

FIG. 4 is a block showing one embodiment of nine neighboring pixels to determine a set of complete color information of a particular pixel in FIG. 2.

FIG. 5 shows different sets of equations to calculate separate color values of a particular pixel according to an interpolation algorithm.

FIG. 6 is a detailed circuit diagram of one embodiment of the process unit in FIG. 3.

FIG. 7 illustrates one embodiment of an image processing method for determining a set of complete color information of a particular pixel.

FIG. 8 shows one embodiment of a first interpolation algorithm utilizing four neighboring pixels for determining a set of complete color information of a particular pixel in a related art.

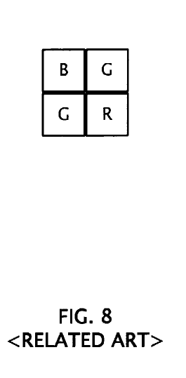

FIG. 9 shows one embodiment of a second interpolation algorithm utilizing nine neighboring pixels for determining a set of complete color information of a particular pixel in a related art.

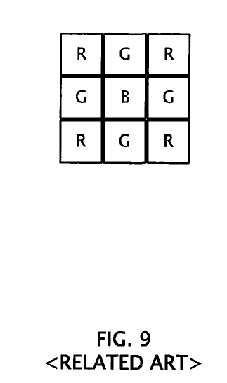

### DETAILED DESCRIPTION OF THE EMBODIMENTS

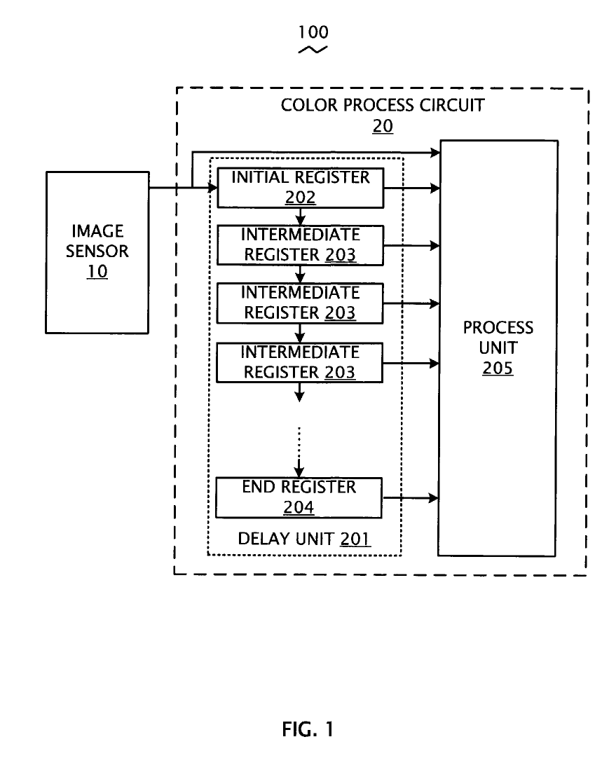

Referring to FIG. 1, a block diagram of one embodiment of an image processing apparatus 100 is illustrated. The image processing apparatus 100 includes an image sensor 10, a color processing circuit 20 electrically coupled to the image sensor 10. The image sensor 10 is configured for capturing incident light from an object, and converting the incident light into image signals. The color processing circuit 20 is configured for processing the image signals from the image sensor 10 to produce a full-color image.

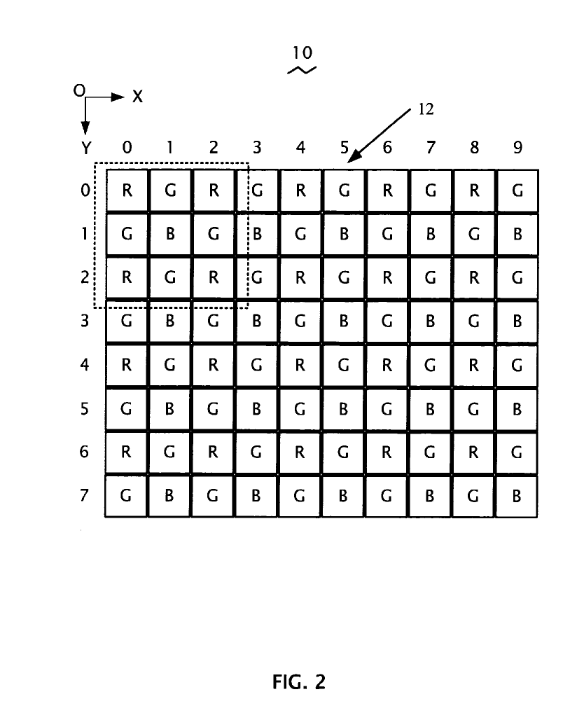

Referring also to FIG. 2, the image sensor 10 includes a plurality of photo-sensors arranged in an array with multiple rows indicated as Y and multiple columns indicated as X, and a color filter array (CFA) 12. The plurality of photo-sensors is also referred as pixels and may be defined by a coordinate system, such as pixel Y[0]X[0], for example. The CFA 12 may be a Bayer pattern including a plurality of tiny color filters, which may be positioned over the plurality of photo-sensors correspondingly. The tiny color filters are configured for filtering the incident light originated from or reflected by the object by wavelength range. The filtered image light is converted into image signals by the photo-sensors correspondingly.

As each photo-sensor is arranged with one corresponding tiny color filter, the image signals for each pixel only contain a single color information. Therefore, the image signals outputted from the image sensor 10 can also be referred as single color image signals.

The color processing circuit 20 in accordance with one exemplary embodiment includes a delay unit 201 and a process unit 205. The delay unit 201 is configured for delaying the image signals generated by the plurality of pixels of the image sensor 10. The process unit 205 is coupled to the delay unit 201. The process unit 205 is capable of reading the image signals belonging to a plurality of pixels simultaneously, and determining a set of complete red, green, and blue color values for each pixel using an interpolation algorithm.

The delay unit 201 includes an initial register 202, a set of intermediate registers 203, and an end register 204. The initial register 202 is connected between an output terminal of the image sensor 10 and an input terminal of the process unit 205. The set of intermediate registers 203 are connected in series between the initial register 202 and the end register 204. Each of the intermediate registers 203 and the end register 204 has an output terminal connected to a corresponding input terminal of the process unit 205. Each of the registers 202, 203, and 204 is configured for storing image signals belonging to one pixel of the image sensor 10.

The number of the registers 203, 204, 205 is determined by a resolution (i.e., a number of pixels) of the image sensor 10 and an interpolation algorithm implemented by the process unit 205. For example, as illustrated in FIG. 2, the image sensor 10 is arranged with a 10×8 array, and has eighty pixels represented from X[0]Y[0] to X[9]Y[7]. A first interpolation algorithm of utilizing nine neighboring pixels is implemented by the process unit 205 to determine a set of complete red, green, and blue color values for each pixel. Because in order to determine a set of complete red, green, and blue color values of the first pixel X[0]Y[0], at least the image signals of the pixels X[0]Y[0]-X[0]Y[2], X[1]Y[0]-X[1]Y[2], and X[2]Y[0]-X[2]Y[2] should be known. Also, because the image sensor 10 serially transfers the image signals to the registers, so ten pixels of the first row X[0], ten pixels of the second row X[1] should be, and two pixels of the third row X[2] should be serially transferred from the image sensor 10 and stored in the registers. Therefore, the number of the registers 202, 203, and 204 is arranged at least to be twenty-two. The initial register 202 is the first register. The intermediate registers 203 are the second registers, the third registers, and so on. The end register 204 is the twenty-second register.

The process unit 205 not only has multiple input terminals connected to the registers 202, 203, and 204, but also is directly connected to the output terminal of the image sensor 10. The process unit 205 selectively retrieves the image signals stored in the registers 202, 203, and 204, for determining the set of complete red, green, and blue color values for each pixel.

When the image sensor 10 is enabled to capture the incident light from the object, the image signals are serially transmitted from the initial register 202, to the intermediate register 203, and to the end register 204. When the end register 204 is present with image signals, it means that image signals of the first row, second row and two pixels of the third row of the array of the image sensor 10 are stored in the registers 202, 203, and 204. The twentieth register 203, the twenty-first register 203, and the twenty-second register 204 store image signals of the pixels Y[0]X[2], Y[0]X[1], and Y[0]X[0] respectively. The eleventh register 203, the twelfth register 203, and the thirteenth register 203 store image signals of the pixels Y[1]X[2], Y[1]X[l], and Y[1]X[0] respectively. The first register 202 and the second register 203 store image signals of the pixels Y[2]X[1] and Y[2]X[0] respectively. In this condition, a set of complete red, green, and blue color values of the pixel Y[0]X[0] can be determined, which will be further described below.

When the process unit 205 is triggered by a clock signal, the process unit 205 retrieves the image signals from the twentieth register 203, the twenty-first register 203, the twenty-second register 204, the eleventh register 203, the twelfth register 203, the thirteenth register 203, the first register 202, the second register 203, and directly from the image sensor 10. In other words, image signals of nine neighboring pixels relating to the pixel Y[0]X[0] are obtained.

Then, an interpolation algorithm is implemented by the process unit 205 to determine a set of complete red, green, and blue color values of the pixel Y[0]X[0]. For example, one embodiment of the interpolation algorithm to determine the set of red, green, and blue values of the pixel Y[0]X[0] may be calculated according to the following three equations:

R=(Y[0]X[0]+Y[2]X[0]+Y[0]X[2]+Y[2]X[2])/4 (EQ 1)

G=(Y[0]X[1]+Y[1]X[0]+Y[1]X[2]+Y[1]X[2])/4 (EQ 2)

B=Y[1]X[1] (EQ 3)

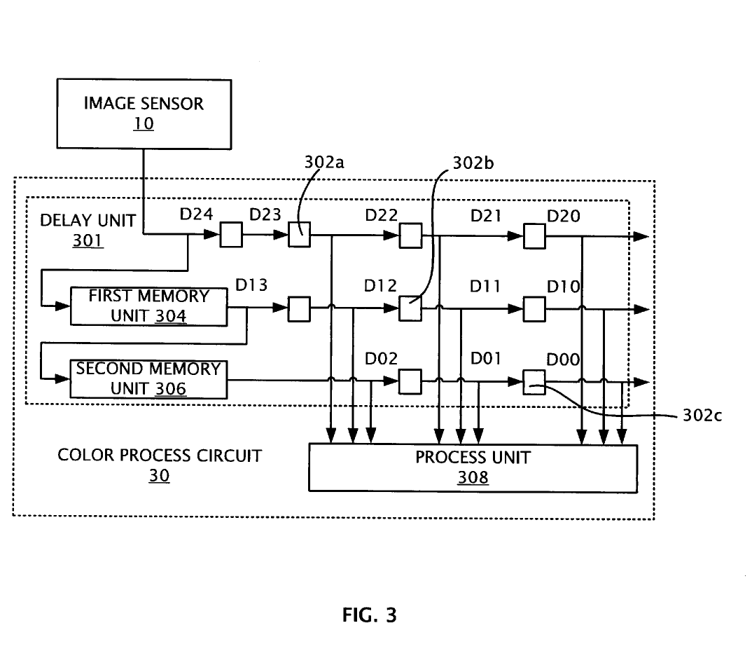

Referring to FIG. 3, another embodiment of a color processing circuit 30 is illustrated. The color processing circuit 30 includes a delay unit 301 and a process unit 308. The delay unit 301 further includes a plurality of first registers 302a, second registers 302b, third registers 302c, a first memory unit 304, and a second memory unit 306. The first memory unit 304 and the second memory unit 306 may be random access memories (RAMs).

The first memory unit 304 and the second memory unit 306 are connected in series to an output terminal of the image sensor 10. The first memory unit 304 and the second memory unit 306 are configured for storing image signals of all pixels of the image sensor 10 arranged in adjacent rows. For example, when the image sensor 10 has a resolution of 1024*768 (1024 columns and 768 rows), the first memory unit 304 and the second memory unit 306 can store the image signals generated by pixels of the image sensor 10 arranged in the first row Y[0] and the second row Y[1] respectively.

The first registers 302a are also connected in series to the output terminal of the image sensor 10. The second registers 302b are connected in series to an output terminal of the first memory unit 304. The third registers 302c are connected in series to an output terminal of the second memory unit 304. The first registers 302a are configured for delaying the image signals directly outputted from the image sensor 10. The second registers 302b are configured for delaying the image signals directly outputted from the first memory unit 304. The third registers 302c are configure for delaying the image signals directly outputted from the second memory unit 306.

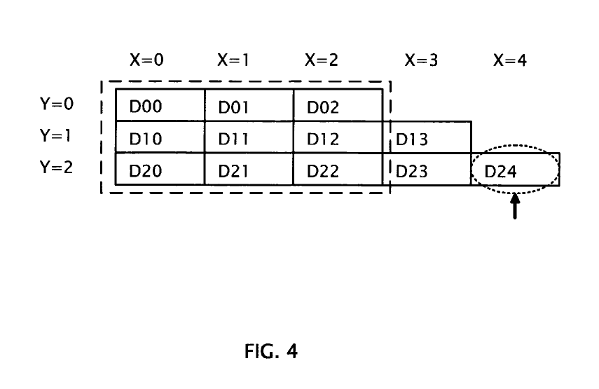

Referring also to FIG. 4, for example, four of the first registers 302a delays image signals directly outputted from the image sensor 10. When the image signals generated by a pixel Y[2]X[4] is D24, the image signals D20-D23 stored in the four of the first registers 302a (hereinafter, “the four first registers”) belong to four pixels Y[2]X[0]-Y[2]X[3] arranged in row Y[2]. Similarly, three of the second registers 302b (hereinafter, “the three second registers”) stored with image signals D10-D12 belong to three pixels Y[1]X[0]-Y[1]X[2] arranged in row Y[1]. Two of the third registers 302c (hereinafter, “two third registers”) are used for storing image signals D00-D01 belonging to two pixels Y[0]X[0]-Y[0]X[1] arranged in row Y[0].

The process unit 308 has multiple input terminals connected to the four first registers 302a, the three second registers 302b, the two third registers 302c, and the output terminal of the second memory unit 306. The process unit 308 is configured for reading the image signals stored in the first registers 302a, the second registers 302b, the two third registers 302c, and the second memory unit 306. When the third registers 302c are present with the image signals D00-D02, the process unit 308 will be triggered by a clock signal to read the image signals stored in the first registers 302a, the second registers 302b, the third registers 302c, and the second memory unit 306 relating to nine neighboring pixels X[0]Y[0]-X[2]Y[0], X[0]Y[1]-X[2]Y[1], and X[0]Y[2]-X[2]Y[2].

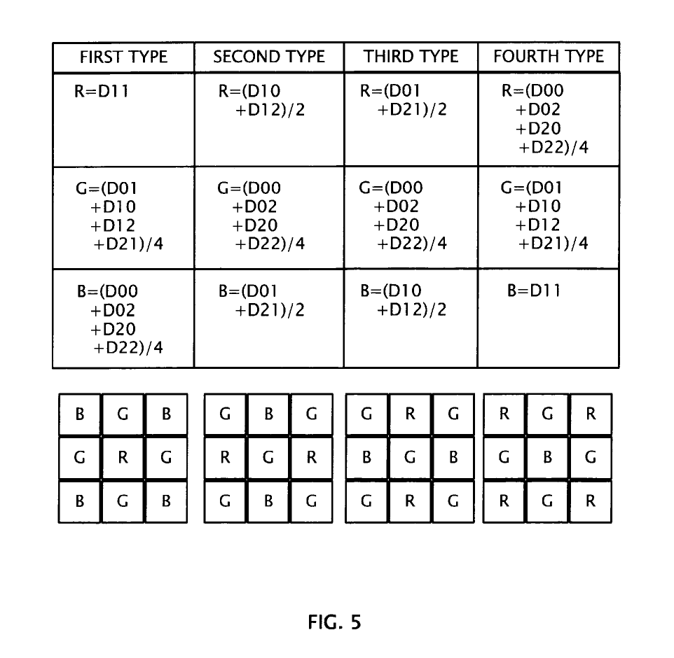

After the image signals of the nine neighboring pixels are obtained, the process unit 308 determines a set of complete red, green, and blue values of a particular pixel using an interpolation algorithm as will be further described below. Because nine neighboring pixels of a Beyer pattern can be arranged in four ways, so there is four set of equations which can be utilized to calculate the complete color information of the particular pixel. Referring also to FIG. 5, four sets of equations are illustrated to calculate the complete color information of the particular pixel.

For example, in a first type, three equations EQ 4-EQ 6 utilized for calculating the set of complete red, green, and blue values of the pixel X[1]Y[1] are set forth as below:

R=D11 (EQ4)

G=(D01+D10+D12+D21])/4 (EQ 5)

B=(D00+D02+D20+D22])/4 (EQ 6)

In a second type, three equations EQ 7-EQ 9 for calculating the set of complete red, green, and blue values of other pixels are set forth as below:

R=(D10+D12)/2 (EQ 7)

G=(D00+D02+D20+D22])/4 (EQ 8)

B=(D01+D21)/2 (EQ 9)

In a third type, three equations EQ 10-EQ 12 for calculating the set of complete red, green, and blue values of other pixels are set forth as below:

R=(D01+D21)/2 (EQ 10)

G=(D00+D02+D20+D22])/4 (EQ 11)

B=(D10+D12)/2 (EQ 12)

In a fourth type, three equations EQ 13-EQ 15 for calculating the set of complete red, green, and blue values of other pixels are set forth as below:

R=(D00+D02+D20+D22])/4 (EQ 13)

G=(D01+D10+D12+D21])/4 (EQ 14)

B=D11 (EQ 15)

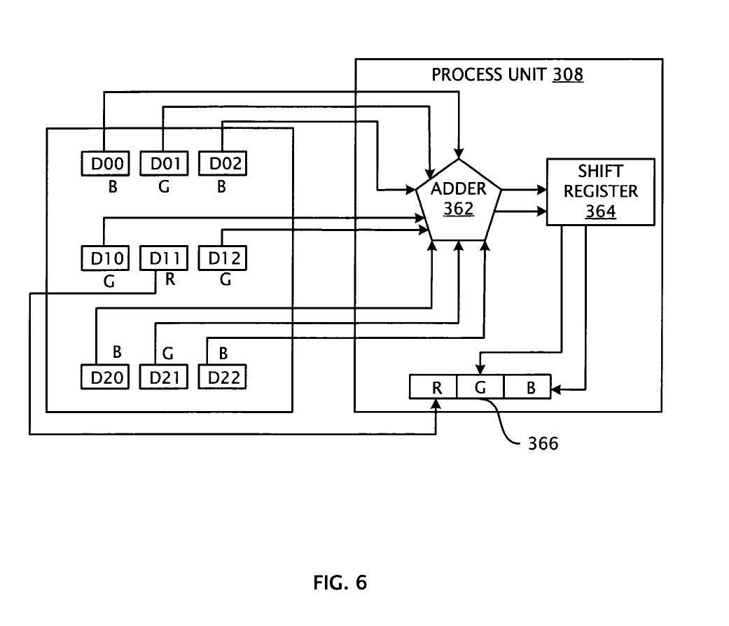

Referring to FIG. 6, a detailed diagram of one embodiment of the process unit 308 determining a set of complete red, green, and blue values of a particular pixel is illustrated. The process unit 308 includes an adder 362, a shift register 364, and a storage unit 366. The adder 362 is configured for receiving the image signals generated from each pixel of the image sensor 10, and performing an add operation with the received image signals to generate sum data according to the above mentioned equations.

The shifter register 364 is electrically connected to the adder 362. The shift register 364 are configured for receiving sum data from the adder 362, and performing a divide operation to the sum data. More specifically, when the sum data received from the adder 362 is divided by four, the shift register 364 moves binary data stored right by two bits. When the sum data received from the adder 362 is divided by two, the shift register 364 moves binary data stored right by one bits.

The storage unit 366 is electrically connected to the shift register 364. The storage unit 366 is divided into three blocks which are configured for storing a set of complete red, green, and blue values of a particular pixel respectively.

As described above, the color processing circuits 20, 30 utilize a plurality of registers to delay image signals outputted from the image sensor 10. With these registers, the process units 205, 308 can be triggered to simultaneously retrieve color information of image signals relating to a particular pixel, such that a set of complete color information of the particular pixel of the image sensor 10 can be determined when the image sensor is outputting image signals to the process unit 205. Consequently, the process unit 308 saves much time in determining the complete color information. As soon as the image sensor 10 outputs all image signals of each pixel, the process unit 205 can utilize the complete color information to do further processing, such as image sharpening and color correction to construct a full-color image.

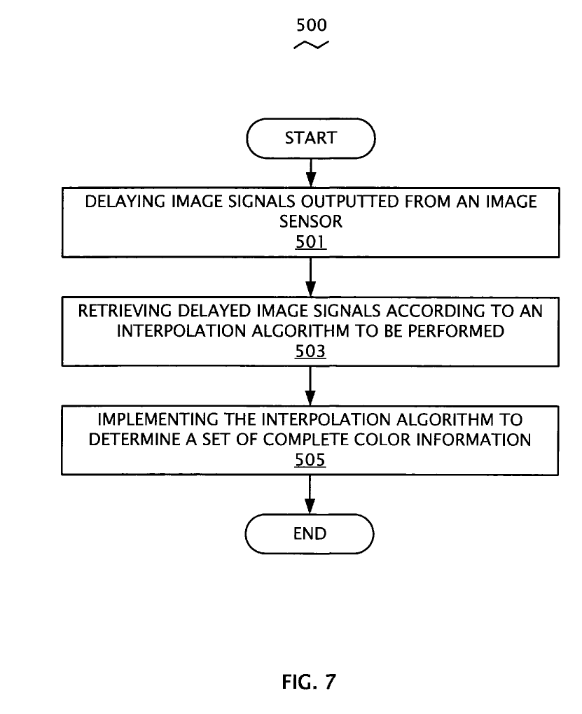

Referring to FIG. 7, an image processing method 500 for processing image signals outputted from an image sensor in accordance with one embodiment of the present disclosure is illustrated. The image processing method 500 may be implemented by the image processing apparatus 100 illustrated in FIG. 1. The various actions in the image processing method 500 may be performed in the order presented, or may be performed in a different order. Furthermore, in some embodiments, some actions listed in FIG. 7 may be omitted from the image processing method 500.

At block 501, an action is performed for delaying image signals outputted from an image sensor 10. The image sensor 10 may include a color filter array (CFA) 12, such that the image signals from the image sensor 10 contain single color information for each pixel. The action at block 502 may be performed by a delay unit 201 (see FIG. 1) including a plurality of registers 202, 203, and 204. The action at block 502 may also be performed by a delay unit 301 (see FIG. 2) including a plurality of registers 302a, 302b, and 302c in combination with a first memory unit 304 and a second memory unit 306. The number of the registers is determined by an interpolation algorithm implemented by the process unit 205 and a resolution of the image sensor 10 for determining a set of complete color information for each pixel of the image sensor 10. For example, a first algorithm utilizing nine neighboring pixels to determine the color information is performed, and the resolution of the image sensor 10 is 10*8. The number of registers 202, 203, and 204 is arranged to be twenty-two.

At block 503, an action is performed for retrieving multiple delayed image signals according to an interpolation algorithm. The action at block 503 may be performed by the process unit 205 or the process unit 308. The multiple image signals are retrieved according to the interpolation algorithm to be performed. For example, a first algorithm utilizing nine neighboring pixels to determine the color information is performed, and nine image signals with respect to a particular pixel is retrieved to determine the complete color information.

At block 505, an action is performed for implementing the interpolation algorithm. For example, a first algorithm utilizing nine neighboring pixels to determine the color information is performed. The process unit 204 may choose a first type of three equations EQ 4-EQ 6 set forth as below for calculating a set of complete red, green, and blue values of a pixel X[1]Y[1].

R=D11 (EQ 4)

G=(D01+D10+D12+D21])/4 (EQ 5)

B=(D00+D02+D20+D22])/4 (EQ 6)

As described above, the method 500 is performed by a first action of delaying multiple image signals outputted from the image sensor 10 utilizing a plurality of registers. By delaying the multiple image signals belonging to multiple pixels of the multiple image signals, a second action of retrieving the multiple image signals simultaneously can be performed a process unit 205. As such, a third action of determining a set of complete color information of a particular pixel of the image sensor 10 can be performed by the process unit 205 according to an interpolation algorithm. Consequently, the process unit 308 saves much time in determining complete color information. As soon as the image sensor 10 outputs all image signals of each pixel, the process unit 205 can utilize the complete color information to do further processing, such as image sharpening and color correction to construct a full-color image. It may be understood that a substantially similar process may be used for single color image signals.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments of the present disclosure.

What is claimed is:

1. An image processing apparatus comprising:
an image sensor comprising a plurality of photo-sensors arranged in an array having multiple rows and multiple columns, and a color filter array positioned over the multiple photo-sensors, the color filter array configured for filtering image light originating from an object to generate a single color image light, the plurality of photo-sensors configured for converting the single color image light to generate single color image signals, the single color image signals belonging to each photo-sensor containing color information selected from the group consisting of red, blue, or green; and
a color processing circuit coupled to the image sensor, the color processing circuit comprising:
a delay unit configured for receiving single color image signals outputted from the image sensor, and delaying the received single color image signals belonging to a plurality of pixels for storing in the delay unit; and
a process unit coupled to the delay unit, the process unit configured for retrieving the single color image signals simultaneously, and determining a set of complete red, green, and blue values for at least part of pixels of the image sensor using an interpolation algorithm.

2. The image processing apparatus of claim 1, wherein the delay unit comprises:
an initiate register, a plurality of intermediate register, and an end register, the initiate register is electrically connected between an output terminal of the image sensor and the process unit, the plurality of intermediate registers are connected in series between the initiate register and the end register, each of the plurality of intermediate registers and the end register having one output terminal electrically connected to corresponding multiple input terminals of the process unit, the initiate register, the plurality of intermediate registers, and the end registers are configured for delaying the single color image signals outputted from the image sensor and storing the single color image signals relating to multiple pixels of the single color image signals.

3. The image processing apparatus of claim 2, wherein the process unit retrieves the single color image signals from the initiate register, the plurality of intermediate registers, and the end register simultaneously, and determining the set of complete red, green, and blue values for at least part of pixels of the image sensor using an interpolation algorithm.

4. The image processing apparatus of claim 2, wherein the process unit further comprises:
an adder configured for performing an add operation with respect to the single color image signals retrieved from the initiate register, the plurality of intermediate registers, and the end register, and generating a sum data; and
a shift registers electrically coupled to the adder for performing a divide operation with respect to the sum data to determine the set of complete red, green, and blue values for at least part of pixels of the image sensor.

5. The image processing apparatus of claim 1, wherein the delay unit comprises:
a plurality of first registers, a plurality of second registers, and a plurality of third registers, the plurality of first registers electrically connected in series to an output terminal of the image sensor for directly delaying the single color image signals belonging to multiple pixels arranged in a first row;
a first memory unit, the first memory unit comprises a first terminal electrically connected to the output terminal of the image sensor and a second terminal electrically connected the plurality of second registers in series, the plurality of second registers are configured for delaying the single color image signals belonging to multiple pixels arranged in a second row neighboring the first row; and
a second memory unit, the second memory unit has a first terminal electrically connected to the second terminal of the first memory unit, and a second terminal electrically connecting the plurality of the third registers in series, the plurality of third registers configured for delaying the single color image signals belonging to multiple pixels arranged in a third row neighboring the first row and the second row.

6. The image processing apparatus of claim 5, wherein the process unit retrieves the single color image signals from the plurality of first registers, the plurality of second registers, and the plurality of third registers simultaneously, and determines the set of complete red, green, and blue values for at least part of pixels of the image sensor using an interpolation algorithm.

7. The image processing apparatus of claim 6, wherein the process unit further comprises:
an adder configured for performing an add operation with respect to the single color image signals retrieved from the initiate register, the plurality of intermediate registers, and the end register, and generating a sum data; and
a shift register electrically coupled to the adder for performing a divide operation with respect to the sum data to determine the set of complete red, green, and blue values for at least part of pixels of the image sensor.

8. A color processing circuit for producing a full-color image by processing single color image signals outputted from an image sensor having a plurality of photo-sensors arranged in multiple rows and columns and a color filter array positioned over the plurality of photo-sensors, the color processing circuit comprising:
a plurality of first registers, a plurality of second registers, and a plurality of third registers, the plurality of first registers configured for receiving and storing the single color image signals belonging to multiple pixels arranged in a first row from the image sensor;
a first memory unit configured for receiving the single color image signals outputted from the image sensor, and storing the single color image signals belonging to whole pixels arranged in a second row neighboring the first row, the first memory unit outputting single color image signals belonging to a part of the pixels arranged in the second row to the plurality of second registers; and
a second memory unit configured for receiving the single color image signals outputted from the first memory unit, and storing the single color image signals belonging to whole pixels arranged in a third row neighboring the second row, the second memory unit outputting single color image signals belonging to a part of the pixels arranged in the third row to the plurality of the third registers.

9. The color processing circuit of claim 8, further comprising a process unit configured for retrieving single color image signals from the image sensor, the plurality of first registers, the plurality of second registers, and the plurality of third registers, the process unit determining a set of complete red, green, and blue values for at least part of pixels of the image sensor using an interpolation algorithm.

10. The color processing circuit of claim 9, wherein the process unit further comprises:
an adder configured for performing an add operation to the single color image signals retrieved from the initiate register, the plurality of intermediate registers, and the end register, and generating a sum data; and
a shift register electrically coupled to the adder for performing a divide operation to the sum data to determine the set of complete red, green, and blue values for at least part of pixels of the image sensor.

11. An image processing method for processing single color image signals generated from an image sensor by a color processing circuit, the image processing method comprising:
delaying the single color image signals belonging to multiple pixels by a plurality of registers and storing the single color image signals belonging to multiple pixels in the plurality of registers;
retrieving the single color image signals stored in the plurality of registers simultaneously by a process unit;
determining a set of complete red, green, and blue values of at least part pixels of the image sensor with respect to the retrieved single color image signals using an interpolation algorithm.

12. The image processing method of claim 11, wherein action of delaying further comprises:
delaying the single color signals belonging to multiple pixels arranged in a first row by a plurality of first registers;
delaying the single color signals belonging to multiple pixels arranged in a second row neighboring the first row by a plurality of second registers; and
delaying the single color signals belonging to multiple pixels arranged in a third row neighboring the second row by a plurality of third registers.

13. The image processing method of claim 11, wherein action of retrieving further comprises:
retrieving the single color image signals from the plurality of the first registers, the plurality of second registers, and the plurality of the third registers simultaneously.

14. The image processing apparatus of claim 11, wherein action of determining further comprises:
determine a set of complete red, green, and blue values of at least part pixels of the image sensor with respect to the retrieved single color image signals belonging to nine neighboring pixels using an interpolation algorithm.
